(19) United States
(12) Patent Application Publication
(10) Pub. No.: US 2011/0205732 A1
(43) Pub. Date: Aug. 25, 2011

(54) ILLUMINATING DEVICE AND DISPLAY DEVICE

(75) Inventor: Masashi Yokota, Osaka-shi (JP)

(73) Assignee: SHARP KABUSHIKI KAISHA, Osaka-shi, Osaka (JP)

(21) Appl. No.: 13/122,441

(22) PCT Filed: May 29, 2009
(86) PCT No.: PCT/JP2009/059848

§ 371 Date: Apr. 4, 2011

(30) Foreign Application Priority Data
Oct. 24, 2008 (JP) 2008-274508

(51) Int. Cl. F21S 4/00

(52) U.S. Cl. 362/221

(57) ABSTRACT

An illuminating device (3) includes a plurality of cold cathode fluorescent tubes (discharge tubes) (9); inverter circuits (drive circuits) (17) that are connected to the plurality of cold cathode fluorescent tubes (9) and respectively light the plurality of cold cathode fluorescent tubes (9); a metal chassis (10) accommodating the plurality of cold cathode fluorescent tubes (9); and a reflecting sheet (11) formed of synthetic resin for reflecting light from the plurality of cold cathode fluorescent tubes (9). The chassis (10) is provided with a frame-shaped frame body (10a), and a plurality of rib members (10b) arranged respectively for the plurality of cold cathode fluorescent tubes (9) and attached to the frame body (10a) in parallel to the longitudinal direction of the cold cathode fluorescent tubes (9) on a side directly below the cold cathode fluorescent tubes (9).

### TECHNICAL FIELD

The present invention relates to an illuminating device, in particular, an illuminating device using discharge tubes such as cold cathode fluorescent tubes, and a display device using the illuminating device.

### BACKGROUND ART

In recent years, for example, in TV receivers for household use, display devices are becoming mainstream, which have a liquid crystal panel as a flat display portion with a number of features such as thinness and light weight, compared with conventional Braun tubes, as typified by liquid crystal display devices. Such a liquid crystal display device is provided with an illuminating device (backlight) that emits light and a liquid crystal panel that displays a desired image by playing a shutter role with respect to light from light sources provided in the illuminating device. ATV receiver is designed to display information such as characters and images contained in video signals for TV broadcasting on a display surface of the liquid crystal panel.

Further, the above-mentioned illuminating devices are classified roughly into a direct type and an edge-light type depending upon the arrangement of light sources with respect to the liquid crystal panel. A liquid crystal display device having a liquid crystal panel of 20 inches or more generally uses the direct type illuminating device that can achieve an increase in brightness and enlargement more easily than the edge-light type illuminating device. More specifically, the direct type illuminating device is configured in such a manner that a plurality of light sources are placed on a back (non-display surface) side of a liquid crystal panel, and the light sources can be placed directly on a back side of the liquid crystal panel. This enables the use of a number of light sources and makes it easy to obtain high brightness, and thus, the direct type illuminating device is suitable for an increase in brightness and enlargement. Further, the direct type illuminating device is light-weight even when it is enlarged, due to its hollow structure in the device, which also renders the direct type illuminating device to be suitable for an increase in brightness and enlargement.

Further, in the conventional illuminating device as described above, for example, as described in the following Patent Document 1, a metal chassis accommodating a plurality of cold cathode fluorescent tubes as light sources is formed of a frame-shaped frame body, and one opening side of the frame body is covered with a reflecting sheet made of synthetic resin so that light from the cold cathode fluorescent tubes is emitted from the other opening side of the frame body. Accordingly, in the conventional illuminating device, the weight of the illuminating device can be reduced compared with the case of using a bottomed metal chassis with only one side being opened.

### PRIOR ART DOCUMENT

### Patent Document

Patent document 1: JP 2005-347005 A

### DISCLOSURE OF INVENTION

### Problem to be Solved by the Invention

However, in the conventional illuminating device as described above, there arises a problem that the lighting properties of each of a plurality of cold cathode fluorescent tubes (discharge tubes) are degraded by the reduction in weight.

Specifically, in the conventional illuminating device, in order to reduce the weight thereof, a reflecting sheet made of synthetic resin is provided in place of a chassis bottom surface made of metal, and thus, a leakage current does not flow through the reflecting sheet when cold cathode fluorescent tubes are lit, unlike the case of using a chassis bottom surface made of metal. Therefore, in the conventional illuminating device, it is requested to increase a start voltage for starting the lighting of cold cathode fluorescent tubes in drive circuits that are connected to the cold cathode fluorescent tubes and light the cold cathode fluorescence tubes. In particular, when an ambient temperature is low, it is necessary to increase the start voltage substantially, which degrades the lighting properties of the cold cathode fluorescent tubes remarkably.

In view of the above-mentioned problem, an object of the present invention is to provide an illuminating device capable of preventing the lighting properties of discharge tubes from being degraded even when the weight of the illuminating device is reduced, and a display device using the illuminating device.

### Means for Solving Problem

In order to achieve the above-mentioned object, an illuminating device according to the present invention includes: a plurality of discharge tubes; a drive circuit that is connected to any of the plurality of discharge tubes and lights any of the plurality of discharge tubes; a metal chassis accommodating the plurality of discharge tubes; and a reflecting sheet formed of synthetic resin for reflecting light from the plurality of discharge tubes, wherein the chassis is provided with a frame body formed in a frame shape, and a plurality of rib members arranged respectively for the plurality of discharge tubes and attached to the frame body in parallel to a longitudinal direction of the discharge tubes on a side directly below the discharge tubes.

In the illuminating device configured as described above, the frame body formed in a frame shape is provided in the metal chassis accommodating a plurality of discharge tubes. Therefore, the weight of the chassis and the weight of the illuminating device can be reduced. Further, a plurality of rib members are set in the chassis, which are provided respectively for the plurality of discharge tubes and attached to the frame body in parallel to the longitudinal direction of the discharge tubes on a side directly below the discharge tubes. Thus, unlike the above-mentioned conventional example, when the discharge tube is lit, a leakage current is allowed to flow to the corresponding rib member, which makes it unnecessary to increase a start voltage in the drive circuit. Accordingly, unlike the conventional example, an illumination device can be configured, which is capable of preventing the lighting properties of the discharge tubes from being degraded even when the illuminating device is reduced in weight.

Further, in the above-mentioned illuminating device, it is preferred that a discharge tube support member supporting the corresponding discharge tubes is attached to the rib member.

In this case, an illumination device excellent in light-emission quality can be configured easily, in which the discharge tubes can be attached to the chassis with good precision.

Further, the above-mentioned illuminating device may include a diffusion plate that is provided on one opening side of the frame body so as to cover the opening and diffuses light from the plurality of discharge tubes, and a diffusion plate support member that supports the diffusion plate, wherein the chassis is provided with a connecting member which is connected to at least one side of the frame body and the rib members and to which the diffusion plate support member is attached.

In this case, an illuminating device having excellent light-emission quality can be configured easily, which is capable of preventing the deformation such as bending of the diffusion plate by the diffusion plate support member and preventing the occurrence of uneven brightness exactly.

Further, in the above-mentioned illuminating device, it is preferred that, in the chassis, the reflecting sheet is attached to the frame body so as to cover the other opening side of the frame body.

In this case, the light use efficiency of the discharge tubes can be enhanced exactly.

Further, a display device of the present invention is characterized by using any of the above-mentioned illuminating devices.

The display device configured as described above uses an illuminating device capable of preventing the lighting properties of the discharge tubes from being degraded even when the weight of the illuminating device is reduced. Therefore, a light-weight display device of high performance can be configured easily.

### Effects of the Invention

According to the present invention, an illuminating device capable of preventing the lighting properties of discharge tubes from being degraded even when the weight of the illuminating device is reduced, and a display device using the illuminating device.

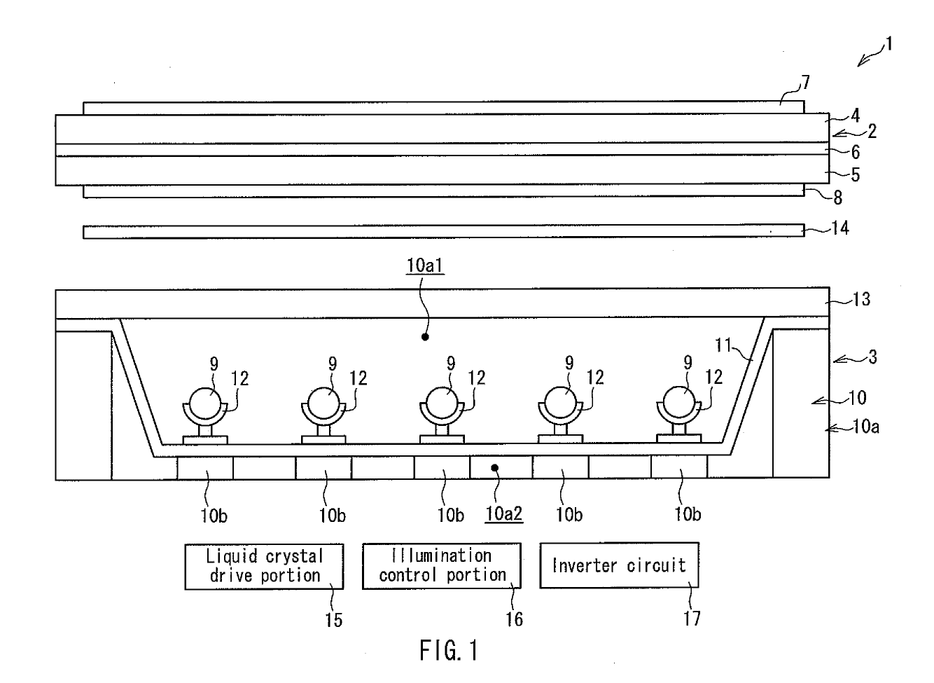

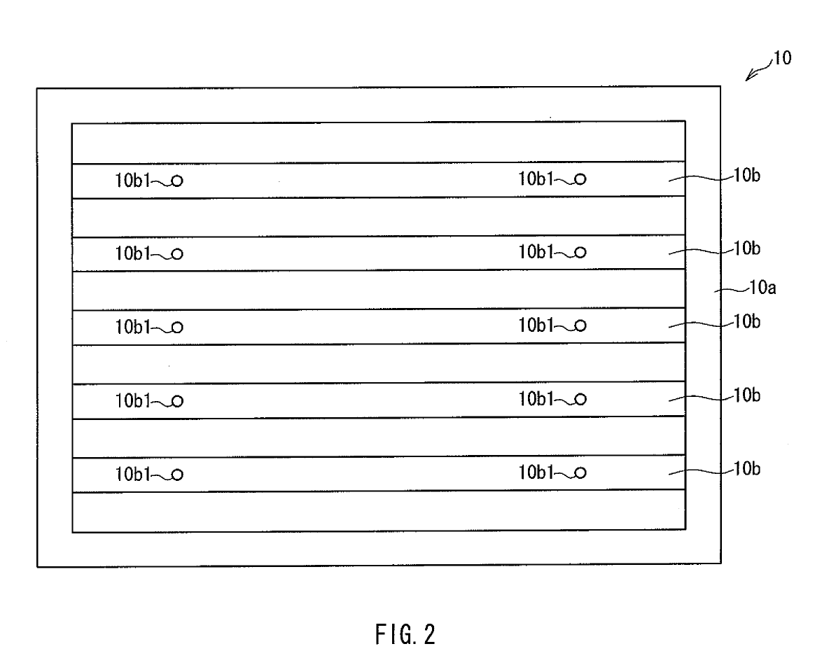

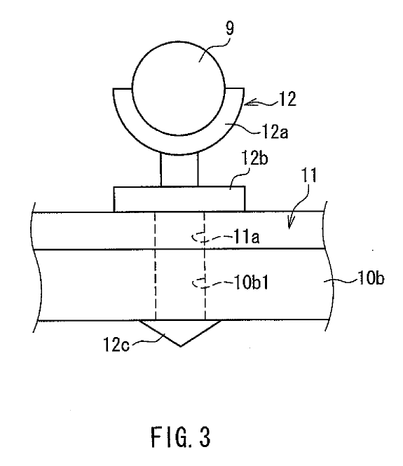

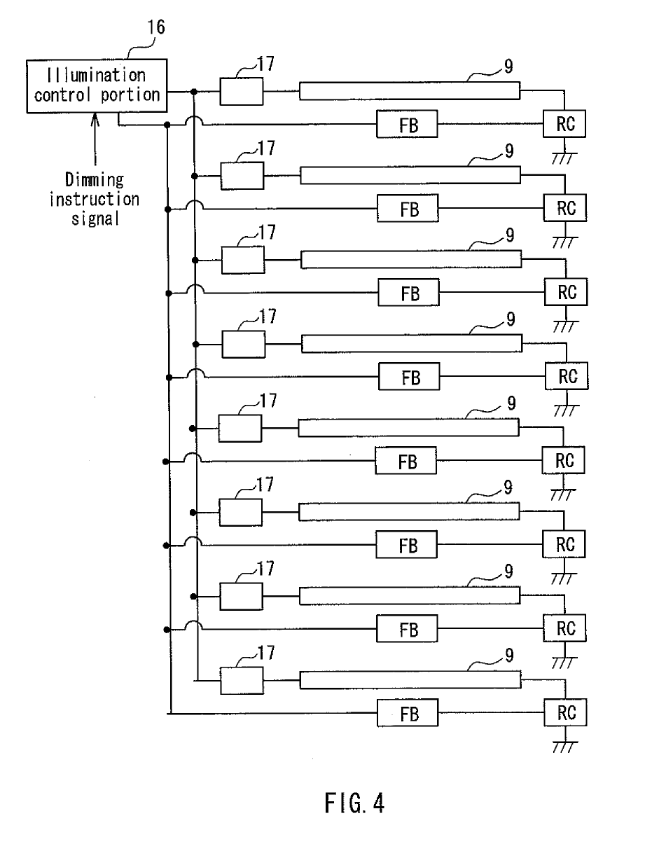

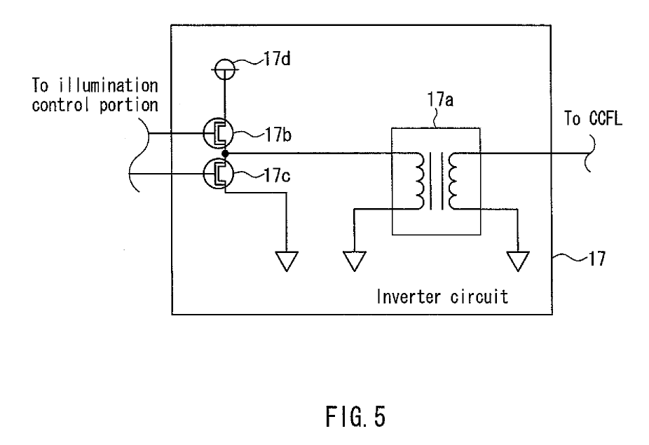

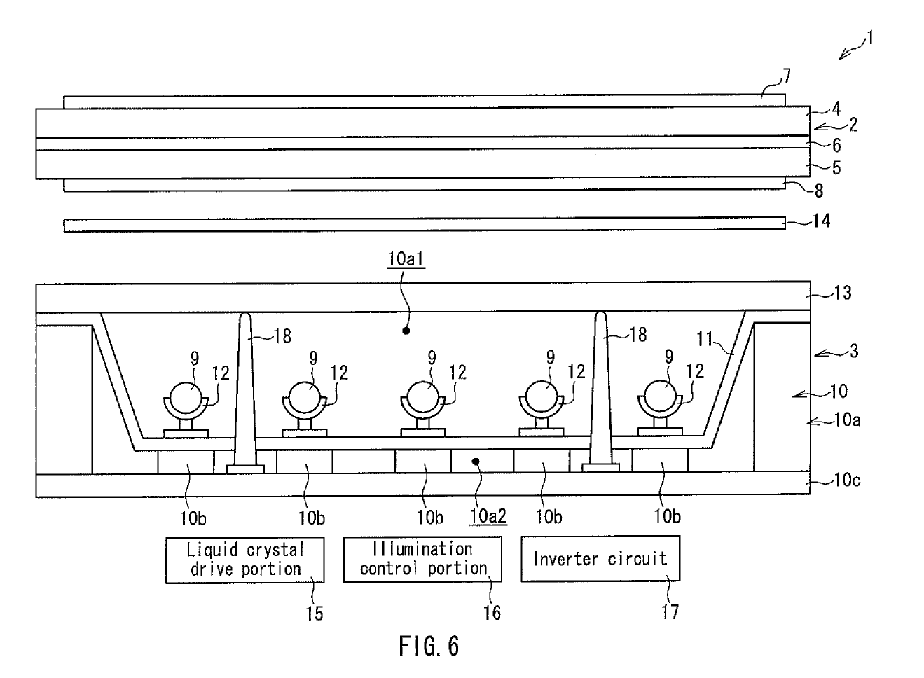

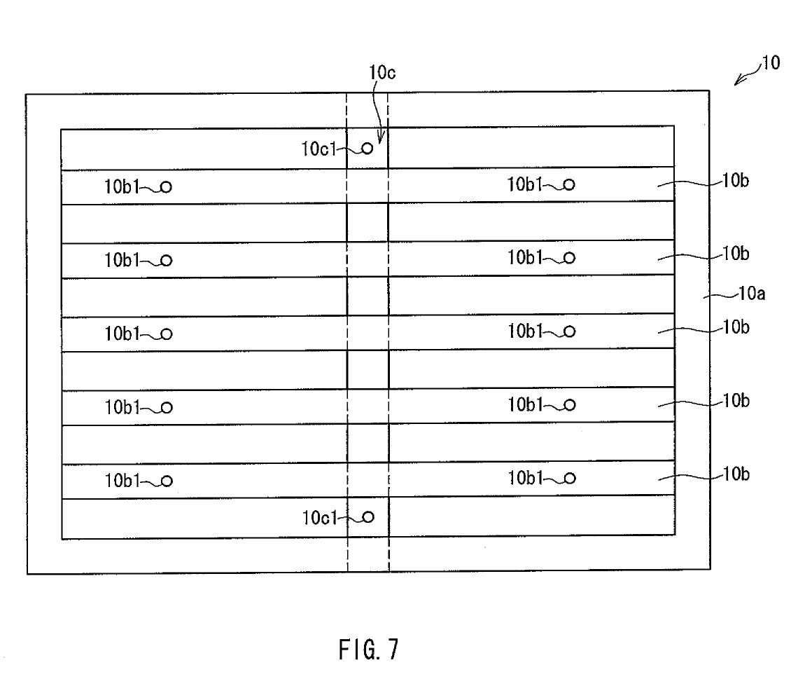

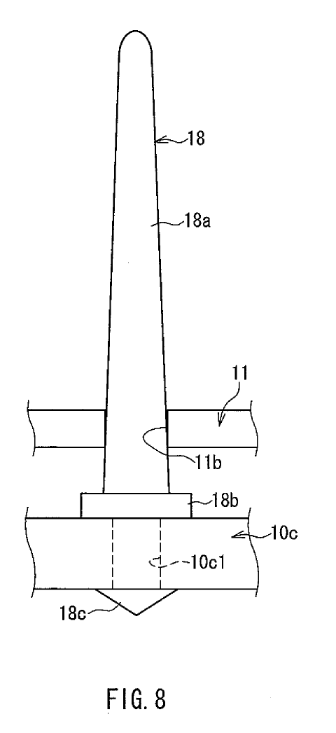

### BRIEF DESCRIPTION OF DRAWINGS

[FIG. 1] FIG. 1 is a view illustrating an illuminating device and a liquid crystal display device according to Embodiment 1 of the present invention.

[FIG. 2] FIG. 2 is a plan view illustrating a chassis of FIG. 1.

[FIG. 3] FIG. 3 is a view illustrating a lamp holder of FIG. 1.

[FIG. 4] FIG. 4 is a diagram illustrating a circuit configuration of the illuminating device of FIG. 1.

[FIG. 5] FIG. 5 is a diagram illustrating a configuration example of an inverter circuit of FIG. 4.

[FIG. 6] FIG. 6 is a view illustrating an illuminating device and a liquid crystal display device according to Embodiment 2 of the present invention.

[FIG. 7] FIG. 7 is a plan view illustrating a chassis of FIG. 6.

[FIG. 8] FIG. 8 is a view illustrating a diffusion plate support member of FIG. 6.

### DESCRIPTION OF THE INVENTION

Hereinafter, an illuminating device of the present invention, and a preferred embodiment of a display device using the illuminating device will be described with reference to the drawings. In the following, description will be made illustrating the case of applying the present invention to a transmission-type liquid crystal display device. Further, it should be noted that the dimensions of constituent members in the respective figures do not faithfully reflect the dimensions of actual constituent members, the size ratios of the respective constituent members, etc.

### Embodiment 1

FIG. 1 is a view illustrating an illuminating device and a liquid crystal display device according to Embodiment 1 of the present invention. In FIG. 1, a liquid crystal display device 1 of the present embodiment is configured using a display element of the present invention, and includes a liquid crystal panel 2 placed with an upper side of FIG. 1 being as a viewer side (display surface side), and an illuminating device 3 that is placed on a non-display surface side (lower side of FIG. 1) of the liquid crystal panel 2 and generates illumination light illuminating the liquid crystal panel 2.

The liquid crystal panel 2 includes a color filter (CF) substrate 4 and an array substrate 5 constituting a pair of substrates, a liquid crystal layer 6 interposed between the CF substrate 4 and the array substrate 5, and polarizing plates 7, 8 provided respectively on outside surfaces of the CF substrate 4 and the array substrate 5 so as to sandwich the CF substrate 4 and the array substrate 5. Further, the liquid crystal panel 2 is configured so that the liquid crystal layer 6 can be driven on a pixel basis by a liquid crystal drive portion describe later. Then, in the liquid crystal panel 2, the polarization state of the illumination light incident through the polarizing plate 8 is modulated by the liquid crystal layer 6, and the amount of light passing through the polarizing plate 7 is controlled. Thus, a desired image is displayed.

The CF substrate 4 and the array substrate 5 are made of a plate-shaped glass member or transparent synthetic resin such as acrylic resin. Further, pixel electrodes, thin film transistors (TFTs), etc. are formed (not shown) on the array substrate 5 so as to be interposed between the array substrate 5 and the liquid crystal layer 6 according to a plurality of pixels included in the display surface of the liquid crystal panel 2. On the other hand, color filters, counter electrodes, etc. are formed (not shown) on the CF substrate 4 so as to be interposed between the CF substrate 4 and the liquid crystal layer 6.

Any suitable liquid crystal mode and pixel structure can be used in the liquid crystal panel 2. Any drive mode can also be used in the liquid crystal panel 2. That is, as the liquid crystal panel 2, any liquid crystal panel capable of displaying information can be used. Therefore, FIG. 1 does not illustrate the detailed structure of the liquid crystal panel 2, and the description thereof is omitted.

Next, also referring to FIGS. 2 and 3, the illuminating device 3 of the present embodiment will be described specifically.

FIG. 2 is a plan view illustrating a chassis of FIG. 1, and FIG. 3 is a view illustrating a lamp holder of FIG. 1.

As illustrated in FIG. 1, the illuminating device 3 is provided with a plurality of (e.g., five) cold cathode fluorescent tubes (CCFLs) 9 and a metal chassis 10 accommodating the cold cathode fluorescent tubes 9. Further, the illuminating device 3 includes a reflecting sheet 11 that reflects light from the cold cathode fluorescent tubes 9 as discharge tubes to the liquid crystal panel 2 side, a diffusion plate 13 that diffuses the light (also containing light reflected from the reflecting sheet 11) from the cold cathode fluorescent tubes 9, and an optical sheet 14 placed above the diffusion plate 13.

As each of the cold cathode fluorescent tubes 9, a thinned straight tube excellent in an emission efficiency with a diameter of about 3.0 to 4.0 mm is used so as to easily configure the illuminating device 3 that is compact in size and excellent in an emission efficiency. Further, each of the cold cathode fluorescent tubes 9 is held inside the chassis 10 while the respective distances from the reflecting sheet 11 and the diffusion plate 13 are kept at predetermined distances by lamp holders 12 as discharge tube support members.

Also referring to FIG. 2, the chassis 10 is provided with a frame body 10a formed in a frame shape and a plurality of rib members 10b arranged respectively for the plurality of cold cathode fluorescent tubes 9. In the frame body 10a, the diffusion plate 13 is placed on one opening 10a1 side so as to cover the opening 10a1. Further, in the frame body 10a, an end of the reflecting sheet 11 is attached, and the reflecting sheet 11 is provided so as to cover the other opening 10a2 side. Further, the reflecting sheet 11 is attached to each of the plurality of rib members 10b by the lamp holders 12, as described later in detail.

The respective rib members 10b are attached to the opening 10a2 side of the frame body 10a in parallel to the longitudinal direction (horizontal direction of FIG. 2) of the cold cathode fluorescent tubes 9 on a side directly below the corresponding cold cathode fluorescent tubes 9. Further, each rib member 10b is set to have a size of, for example, 1 mm or more in the perpendicular direction (vertical direction of FIG. 2) perpendicular to the longitudinal direction. When viewed from the lower side of FIG. 1, the rib members 10b are configured so as to be opposed to the corresponding cold cathode fluorescent tubes 9 with the reflecting sheet 11 and the lamp holders 12 interposed therebetween. Then, the rib members 10b function as proximity conductors permitting a leakage current to flow when the cold cathode fluorescent tubes 9 are lit.

As illustrated in FIG. 2, each rib member 10b has two attachment holes 10b1 to which the lamp holders 12 are attached. Then, in the chassis 10, the cold cathode fluorescent tubes 9 held by the lamp holders 12 are accommodated in the chassis 10 when the lamp holders 12 are attached to the attachment holes 10b1.

Specifically, as illustrated in FIG. 3, the lamp holder 12 includes a semi-circular holding portion 12a holding the cold cathode fluorescent tube 9, a base 12b supporting the holding portion 12a, and an attachment portion 12c extending from the base 12b to a side opposite to the holding portion 12a. The holding portion 12a comes into contact with the surface of the cold cathode fluorescent tube 9 to hold the cold cathode fluorescent tube 9. The base 12b is configured in a plate shape and placed on the surface of the reflecting sheet 11. The attachment portion 12c is configured in a substantially cylindrical shape and inserted in a through-hole 11a provided in the reflecting sheet 11 and the attachment hole 10b1. Further, as illustrated in FIG. 3, a tip end of the attachment portion 12c is configured in a substantially triangular shape in a cross-section, and the tip end protrudes outside of the rib member 10b to be locked on the outer surface of the rib member 10b. Thus, the lamp holder 12 is incorporated in the chassis 10. As the lamp holder 12, for example, transparent or white synthetic resin is used.

The reflecting sheet 11 is formed of synthetic resin such as polyethylene terephthalate (PET) foam and enhances a light use efficiency of the cold cathode fluorescent tubes 9 by reflecting light from the cold cathode fluorescent tubes 9 to the liquid crystal panel 2 side.

The diffusion plate 13 is formed of synthetic resin or glass material. Further, the diffusion plate 13 is held movably on the chassis 10, and is capable of absorbing deformation by moving on the chassis 10, even when the diffusion plate 13 is deformed elastically (plastically) due to the heat generation of the cold cathode fluorescent tubes 9 and the influence of heat such as an increase in temperature in the chassis 10.

The optical sheet 14 includes a diffusion sheet formed of, for example, a synthetic resin film and is configured so as to diffuse the illumination light to the liquid crystal panel 2 appropriately to enhance the display quality on the display surface of the liquid crystal panel 2. Further, a known optical sheet member, which enhances the display quality on the display surface of the liquid crystal panel 2, such as a prism sheet and a polarization reflecting sheet is laminated appropriately on the optical sheet 14, if required. Then, the optical sheet 14 is configured so as to convert planar light output from the diffusion plate 13 into planar light having a predetermined brightness (for example, 10000 cd/m²) and having a substantially uniform brightness, and to allow the converted planar light to be incident upon the liquid crystal panel 2 side as illumination light.

Besides the above-mentioned description, for example, an optical member such as a diffusion sheet for adjusting a viewing angle of the liquid crystal panel 2 may be laminated appropriately above (display surface side of) the liquid crystal panel 2.

Further, as illustrated in FIG. 1, a liquid crystal drive portion 15 for driving the liquid crystal panel 2, an illumination control portion 16 for driving each of the plurality of cold cathode fluorescent tubes 9, and inverter circuits 17 as drive circuits, which are provided for the respective cold cathode fluorescent tubes 9 and light the corresponding cold cathode fluorescent tubes 9 based on a control signal (drive signal) from the illumination control portion 16, are placed on the outer side of the chassis 10.

Hereinafter, a circuit configuration of the illuminating device 3 of the present embodiment will be described specifically, also referring to FIGS. 4 and 5.

FIG. 4 is a diagram illustrating the circuit configuration of the illuminating device illustrated in FIG. 1, and FIG. 5 is a diagram illustrating a configuration example of the inverter circuit illustrated in FIG. 4.

As illustrated in FIG. 4, in the illuminating device 3, the inverter circuits 17 are set on one end side in the longitudinal direction of the respective cold cathode fluorescent tubes 9 and supply currents from one end side to the corresponding cold cathode fluorescent tubes 9. Further, as the inverter circuits 17, for example, those of a half-bridge type are used as described later in detail, and the inverter circuits 17 are configured so as to drive the corresponding cold cathode fluorescent tubes 9 using PWM dimming, based on the drive signal.

Further, the illuminating device 3 includes lamp current detection circuits RC provided for the respective cold cathode fluorescent tubes 9 and detecting values of lamp currents flowing through the corresponding cold cathode fluorescent tubes 9. In the illuminating device 3, a lamp current value detected by each lamp current detection circuit RC is output to the illumination control portion 16 through a feedback circuit FB set according to any of the cold cathode fluorescent tubes 9.

Further, the illumination control portion 16 receives a dimming instruction signal that changes the brightness of a light-emitting surface of the illuminating device 3, for example, as an instruction signal from outside, and in the liquid crystal display device 1, a user is capable of changing the brightness (lightness) on the display surface of the liquid crystal panel 2 appropriately. That is, the illumination control portion 16 is configured so as to receive a dimming instruction signal from an operation input unit such as a remote controller (not shown) provided on the liquid crystal display device 1 side, for example. Then, the illumination control portion 16 determines a duty ratio in the PWM dimming, using the input dimming instruction signal, and determines a target value of a supply current to each of the cold cathode fluorescent tubes 9.

After that, the illumination control portion 16 generates and outputs a drive signal to each of the inverter circuits 17 based on the determined target value, and thus, a value of a lamp current flowing through the corresponding cold cathode fluorescent tube 9 changes. Consequently, the amount of light output from each of the cold cathode fluorescent tubes 9 changes in accordance with the dimming instruction signal, and the brightness on the light-emitting surface of the illuminating device 3 and the brightness on the display surface of the liquid crystal panel 2 are changed suitably in accordance with a user's operation instruction.

Further, the lamp current value actually supplied to each of the cold cathode fluorescent tubes 9 is fed back to the illumination control portion 16 as a detected current value via the corresponding lamp current detection circuit RC and feedback circuit FB. Then, in the illumination control portion 16, feedback control using the detected current value and the target value of a supply current determined based on the dimming instruction signal is performed, whereby a display at a brightness desired by the user is maintained.

As illustrated in FIG. 5, as the inverter circuit 17, a half-bridge type circuit is used, which includes a transformer 17a, first and second switching members 17b, 17c connected to the illumination control portion 16 and provided in series to each other on a primary winding side of the transformer 17a, and a drive power supply 17d connected to the first switching member 17b.

The first and second switching members 17b, 17c are formed, for example, of field electric transistors (FETs), and as described later in detail, respectively receive first and second drive signals different in phase by 180° as the drive signals from the illumination control portion 16. Thus, the first and second switching members 17b and 17c perform ON/OFF control of power supply to the cold cathode fluorescent tube 9 connected to a secondary winding side of the transformer 17a.

The inverter circuit 17 lights the corresponding cold cathode fluorescent tube 9 at a high frequency. More specifically, a high-voltage side terminal of any of the cold cathode fluorescent tubes 9 is connected to the secondary winding of the transformer 17a, and the first and second switching members 17b, 17c perform a switching operation based on the first and second drive signals from the illumination control portion 16, and the transformer 17a supplies power to the corresponding cold cathode fluorescent tube 9 to light the cold cathode fluorescent tube 9.

In the illuminating device 3 of the present embodiment configured as described above, the frame-shaped frame body 10a is provided in the metal chassis 10 accommodating the plurality of cold cathode fluorescent tubes (discharge tubes) 9. Therefore, the chassis 10 and the illuminating device 3 can be reduced in weight. Further, the chassis 10 is provided with the plurality of rib members 10b that are arranged respectively for the plurality of cold cathode fluorescent tubes 9 and attached to the frame body 10a in parallel to the longitudinal direction of the cold cathode fluorescent tubes 9 on a side directly below the cold cathode fluorescent tubes 9. According to this configuration, in the illuminating device 3 of the present embodiment, unlike the conventional example, when the cold cathode fluorescent tube 9 is lit, a leakage current is allowed to flow to the corresponding 11b member 10b, which makes it unnecessary to increase a start voltage in the inverter circuit (drive circuit) 17. Thus, in the present embodiment, unlike the conventional example, the illuminating device 3 can be configured, which is capable of preventing the lighting properties of the cold cathode fluorescent tubes 9 from being degraded even when the illuminating device is reduced in weight.

Further, in the present embodiment, the lamp holders (discharge tube support members) 12 supporting the corresponding cold cathode fluorescent tubes 9 are attached to the rib members 10b. Therefore, the cold cathode fluorescent tubes 9 can be attached to the chassis 10 with good precision, and the illuminating device 3 excellent in light-emission quality can be configured easily.

Further, in the illuminating device 3 of the present embodiment, in the chassis 10, the reflecting sheet 11 is attached to the frame body 10a so as to cover the other opening 10a2 side of the frame body 10a, so that the light use efficiency of the cold cathode fluorescent tubes 9 can be enhanced exactly.

Further, in the present embodiment, the illuminating device 3 is used, which is capable of preventing the lighting properties of the cold cathode fluorescent tubes 9 from being degraded even when the illuminating device 3 is reduced in weight. Therefore, the liquid crystal display device 1 having light weight and high performance can be configured easily.

### Embodiment 2

FIG. 6 is a view illustrating an illuminating device and a liquid crystal display device according to Embodiment 2 of the present invention, and FIG. 7 is a plan view illustrating the chassis of FIG. 6. In the figures, the main differences between the present embodiment and Embodiment 1 lie in that a diffusion plate support member supporting the diffusion plate is provided, and the diffusion plate support member is attached to a connecting member provided at the chassis. The elements common to those of Embodiment 1 are denoted with the same reference numerals as those therein, and the repeated description thereof will be omitted.

More specifically, as illustrated in FIGS. 6 and 7, in the illuminating device 3 of the present embodiment, the connecting member 10c is provided on a lower side of the rib members 10b so as to be perpendicular to the rib members 10b in the chassis 10. Further, diffusion plate support members 18 supporting the diffusion plate 13 are attached to the connecting member 10c.

Specifically, as illustrated in FIG. 7, the connecting member 10c is connected to a lower side of the frame body 10a and a lower side of the rib members 10b at the center of the longitudinal direction of the chassis 10, in parallel to a perpendicular direction perpendicular to the longitudinal direction of the cold cathode fluorescent tubes 9. Further, the connecting member 10c has attachment holds 10c1 for attaching the diffusion plate support members 18, for example, at two places, and the two diffusion plate support members 18 are set at the chassis 10 via the connecting member 10c. The illuminating device 3 of the present embodiment is configured so that the tip ends of the diffusion plate support members 18 come into contact with the diffusion plate 13 to support the diffusion plate 13 from the inner side of the chassis 10.

Herein, the diffusion plate support member 18 will be described specifically also with reference to FIG. 8.

FIG. 8 illustrates the diffusion plate support member of FIG. 6.

As illustrated in FIG. 8, the diffusion plate support member 18 includes a substantially conical support portion 18a, a base 18b supporting the support portion 18a, and an attachment portion 18c extending from the base 18b to a side opposite to the support portion 18a. The support portion 18a is configured so as to come into contact with the surface of the diffusion plate 13 to substantially support the diffusion plate 13, and is provided so as to pass through a through-hole 11b provided in the reflecting sheet 11. The base 18b is configured in a plate shape and placed on the surface of the connecting member 10c. The attachment portion 18c is configured in a substantially cylindrical shape and is inserted into the attachment hole 10c1. Further, as illustrated in FIG. 8, the tip end of the attachment portion 18c is configured in a triangular shape in a cross-section, and the tip end protrudes outside of the connecting member 10c to be locked on the outside surface of the connecting member 10c. Thus, the diffusion plate support member 18 is incorporated in the chassis 10. The diffusion plate support member 18 is formed of, for example, transparent or white synthetic resin.

Due to the above-mentioned configuration, the illuminating device 3 of the present embodiment can exhibit functions and effects similar to those of Embodiment 1. Further, in Embodiment 3 of the present embodiment, the connecting member 10c is provided at the chassis 10 and the diffusion plate support member 18 is attached to the connecting member 10c. Thus, in the present embodiment, the illuminating device 3 having excellent light-emission quality can be configured easily, which is capable of preventing the deformation such as bending of the diffusion plate 13 by the diffusion plate support member 18 and the occurrence of uneven brightness exactly.

The above-mentioned embodiments are shown merely for illustrative purposes and are not limiting. The technical scope of the present invention is defined by the claims, and all the alterations within the scope equivalent to the configuration recited in the claims also are included in the technical range of the present invention.

For example, in the above-mentioned description, the case where the present invention is applied to a transmission-type liquid crystal display device has been described. However, the illuminating device of the present invention is not limited thereto, and the present invention can be applied to various display devices having a non-light-emitting display portion displaying information such as an image and a character, using light of a light source. Specifically, the illuminating device of the present invention can be used preferably for a semi-transmission type liquid crystal display device, or a projection-type display device using a liquid crystal panel for a light valve.

Further, in the above-mentioned description, the case of using the straight cold cathode fluorescent tubes as discharge tubes has been described. However, the discharge tubes of the present invention are not limited thereto, and other discharge fluorescent tubes such as hot cathode fluorescent tubes and xenon fluorescent tubes can also be used. Further, discharge tubes in a shape other than the straight shape, such as a U-shaped tube and a pseudomonical U-shaped tube, can also be applied.

Further, in the above-mentioned description, the case where one reflecting sheet is attached to the frame body so as to cover the other opening side of the frame body has been described. However, the reflecting sheet of the present invention is not limited thereto, and for example, a plurality of reflecting sheets may be used. More specifically, a plurality of reflecting sheets may be attached between the adjacent two rib members and between the frame body and the rib members, so as to cover the other opening side of the frame body.

Further, in the description of Embodiment 2, the case of using the connecting member provided in the perpendicular direction perpendicular to the longitudinal direction of the cold cathode fluorescent tubes (discharge tubes) has been described. However, the connecting member of the present invention is not limited thereto, and any connecting member can be used as long as it is connected to at least one side of the frame body of the chassis and the rib members and is capable of allowing the diffusion plate support member to be attached thereto.

Further, in the above-mentioned description, the case where so-called one-side drive is performed has been described, in which inverter circuits are provided on one end side of the cold cathode fluorescent tubes, and power is supplied from one end side to the cold cathode fluorescent tubes. However, the present invention is not limited thereto, and the present invention can also be applied to the case where inverter circuits are also provided on the other end so that both sides of the cold cathode fluorescent tubes are driven.

### INDUSTRIAL APPLICABILITY

The present invention is useful for an illuminating device capable of preventing the lighting properties of a discharge tube from being degraded even when the illuminating device is reduced in size, and a display device using the illuminating device.

### DESCRIPTION OF REFERENCE NUMERALS

1 Liquid crystal display device

3 Illuminating device

9 Cold cathode fluorescent tube (discharge tube)

10 Chassis

10a Frame body

10a1, 10a2 Opening

10b Rib member

10c Connecting member

11 Reflecting sheet

12 Lamp holder (discharge support member)

13 Diffusion plate

17 Inverter circuit (drive circuit)

18 Diffusion plate support member

1. An illuminating device, comprising:
a plurality of discharge tubes;
a drive circuit that is connected to any of the plurality of discharge tubes and lights any of the plurality of discharge tubes;
a metal chassis accommodating the plurality of discharge tubes; and
a reflecting sheet formed of synthetic resin for reflecting light from the plurality of discharge tubes,
wherein the chassis is provided with a frame body formed in a frame shape, and a plurality of rib members arranged respectively for the plurality of discharge tubes and attached to the frame body in parallel to a longitudinal direction of the discharge tubes on a side directly below the discharge tubes.

2. The illuminating device according to claim 1, wherein a discharge tube support member supporting the corresponding discharge tubes is attached to the rib member.

3. The illuminating device according to claim 1, comprising a diffusion plate that is provided on one opening side of the frame body so as to cover the opening and diffuses light from the plurality of discharge tubes, and a diffusion plate support member that supports the diffusion plate,
wherein the chassis is provided with a connecting member which is connected to at least one side of the frame body and the rib members and to which the diffusion plate support member is attached.

4. The illuminating device according to claim 1, wherein, in the chassis, the reflecting sheet is attached to the frame body so as to cover the other opening side of the frame body.

5. A display device characterized by using the illuminating device according to claim 1.
